(19) United States
(12) Patent Application Publication
(10) Pub. No.: US 2003/0129390 A1
(43) Pub. Date: Jul. 10, 2003

(54) Method for the production of cross-linkable acrylate contact adhesive materials

(76) Inventors: Marc Husemann, Hamburg (DE); Stephan Zollner, Hamburg (DE); Andreas Schroder, Hamburg (DE)

Correspondence Address: Norris McLaughlin & Marcus, 30th Floor, 220 East 42nd Street, New York, NY, 10017, US

(21) Appl. No.: 10/296,362

(22) PCT Filed: Jun. 15, 2001
(86) PCT No.: PCT/EP01/06798

(30) Foreign Application Priority Data
Jun. 15, 2000 (DE) 10029553.3

(51) Int. Cl. C08F 2/46; C08J 3/28; C09J 133/14; C08F 20/34

(52) U.S. Cl. 428/345; 526/312; 526/328; 522/90

(57) ABSTRACT

The invention relates to a method for the production of a contact adhesive material based on acrylates, characterised in that a) firstly, (co-) polymers are produced by free radical polymerisation from the following monomers: i) a mixture of acrylic monomers, or of acrylic and vinylic monomers, ii) monomers, which contain vinyl groups and with at least one other functional group which is unreactive with relation to radical polymerisations and which is chosen such that it may participate in polymerisation-like reactions with isocyanate groups, making up from 0.1 to 25 wt. % of the monomer mixture, b) by means of a further reaction under addition of isocyanatoethyl acrylate and/or isocyanatoethyl methacrylate, double bonds are introduced along the polymer chain and c) a cross-linking of the polymers is achieved by means of irradiation with energetic radiation after the reaction between the functional groups and the isocyanate groups.

The invention relates to a process for preparing polyacrylates which are functionalized with double bonds and have pressure-sensitively adhesive properties, and whose cohesion is increased by radiation-induced crosslinking, and to an adhesive tape provided with this polyacrylate pressure sensitive adhesive.

Hotmelt pressure sensitive adhesives (hotmelt PSAs) are compounds which combine the properties of hotmelt adhesives with those of pressure sensitive adhesives. Hotmelt PSAs melt at elevated temperatures and cool to form a permanently tacky film which flows adhesively on contact with a substrate. In combination with various substrates, such as paper, fabric, metal and polymer films, for example, it is possible to produce a large number of different products, particularly pressure sensitive adhesive tapes and also labels. These pressure sensitive adhesive products have a broad field of application in the automobile industry, e.g., for fastening or for sealing, or in the pharmaceutical industry, for active substance patches, for example.

The typical coating temperature for hotmelt PSAs lies between 80 and 180° C. In order to minimize the coating temperature, the molecular weight of the hotmelt PSA to be applied should be as low as possible. On the other hand, the PSA must also possess sufficient cohesion, so that in the course of use as a PSA tape the adhesive effect with the substrate is lastingly ensured. In order to increase the cohesion, in turn, a high molecular weight is essential.

In order to solve this problem polymers have been developed which possess side chains. These polymers possess a relatively low molecular weight but contain double bonds along the side chains. Polymers of this kind, such as natural rubber or SBS or SIS, for example, can be crosslinked efficiently using UV radiation or ionizing radiation. In this way it is possible to prepare cohesive PSAs.

This principle cannot be employed analogously for acrylic hotmelt PSAs, since in that case the corresponding acrylates are prepared by free radical polymerization. In this process of polymerization virtually all of the double bonds are reacted, and so crosslinking by way of double bonds can no longer take place.

In addition, instances of gelling occur during the polymerization. One example of this was depicted in U.S. Pat. No. 4,234,662. There, allyl acrylate or allyl methacrylate was used for the polymerization.

Another possibility for the functionalization with double bonds exists by virtue of polymer-analogous reactions. Based on UV-crosslinkable acrylic hotmelts, U.S. Pat. No. 5,536,759 described the reaction of polyacrylates containing hydroxyl or carboxylic acid groups with 1-(1-isocyanato-1-methylethyl)-3-(1-methylethenyl)benzene (m-TMI). There, a copolymerized photoinitiator is required for efficient UV crosslinking. The UV crosslinking is accompanied by other disadvantages, such as low belt speeds and a low depth of UV penetration in the PSA, for example. Ultimately, even added resins can absorb UV light and adversely effect the crosslinking.

Owing to the relatively low reactivity of the allyl groups, however, drastic experimental conditions are necessary for a crosslinking reaction: in particular, high temperatures or a long period of irradiation. For use as PSAs, therefore, the allyl-modified acrylic polymers are unsuitable, since in that case, following the processing of the polyacrylate, its application as a PSA to a backing, for example, crosslinking is desired in order to raise the cohesion. However, high temperatures lead to gelling in the operation, and the adhesive hardens undesirably so that coating, for example, is no longer possible.

Furthermore, polyacrylates with carboxylic acid, hydroxyl, epoxide, and amine groups can be reacted in a polymer-analogous reaction with compounds containing double bonds; in this regard see U.S. Pat. No. 4,665,106. Owing to the low thermal stability of the components involved, however, it has not been possible to apply this reaction to hotmelts. Moreover, operating conditions were disadvantageous owing to the fact that in order to avoid gelling it was necessary to add large amounts of regulator to the polyacrylate.

Generally speaking it can be stated that in existing processes the thermal stability of the polyacrylate compositions is lowered by the incorporation of double bonds, so that polyacrylate compositions modified in this way possess little if any suitability for processing as hotmelts.

It is an object of the invention to provide a process for preparing acrylate-based pressure sensitive adhesives which have viscoelastic behaviour at room temperature and which do not exhibit the disadvantages of the prior art. Gelling of the pressure sensitive adhesives is to be prevented; in particular, the thermal stability of the PSA should not be lost through the incorporation of the double bonds.

This object is achieved, surprisingly and unforeseeably for the skilled worker, by a process as set out in the main claim. The further claims relate to advantageous developments of this process, to the pressure sensitive adhesive prepared in this way, and to a use of said pressure sensitive adhesive.

Claim 1 accordingly relates to a process for preparing an acrylic-based pressure sensitive adhesive. In this process

a) first of all (co)polymers are prepared from the following monomers by free radical polymerization:

i) a mixture of acrylic monomers or of acrylic and vinylic monomers

ii) monomers which contain vinyl groups and each have at least one functional group which is unreactive in respect of free-radical polymerization, the functional groups being chosen such that they are able to undergo polymer-analogous reactions with isocyanato groups,

with a fraction of 0.1 to 25% by weight in the monomer mixture,

b) double bonds are introduced along the polymer chain by a further reaction with the addition of (isocyanatoethyl)acrylic esters and/or (isocyanatoethyl)methacrylic esters, and

c) after the reaction between the functional groups and the isocyanato groups the polymers are crosslinked through exposure to high-energy radiation.

Said monomer mixture may be composed of two or more monomers on an acrylic or vinylic basis. At least one compound group of the different monomers must be substituted by the functional groups set out above.

First of all, through the free-radical copolymerization, the monomers used are reacted, with the monomers containing the functional groups being incorporated into the (co)polymer chains. The average molecular weights of the PSAs which form in the course of the free radical polymerization are chosen so that they lie within a range which is customary for polyacrylate compositions, i.e., between 200 000 and 2 000 000; specifically for further use as hotmelt PSAs, PSAs having average molecular weights of from 250 000 to 800 000 are prepared. The polymerization may be conducted in the presence of an organic solvent, in the presence of water or in mixtures of organic solvents and water. The aim is to minimize the amount of solvent used. Depending on conversion and temperature, the polymerization time is between 6 and 48 hours. The higher the reaction temperature which can be chosen, i.e., the higher the thermal stability of the reaction mixture, the shorter the reaction time that can be chosen.

Then (isocyanatoethyl)acrylic ester and/or (isocyanatoethyl)methacrylic ester are added to the copolymer mixture. In order to introduce the double bonds the saturated polyacrylate is reacted with (isocyanatoethyl)acrylic ester or (isocyanatoethyl)methacrylic ester in a separate reaction. As a result of the free radical polymerization which has already been concluded beforehand, free radicals are avoided, and so no process of gelling occurs.

The reaction takes place between the isocyanato groups and the functional groups, with the acrylic building blocks of the isocyanato compounds being built onto the polymer chain as side chains, with retention of their double bonds. The linkage sites in this case are the polymer chain atoms that were originally occupied by the functional groups.

The reaction here is generally an addition reaction; where appropriate, it may be followed by elimination. The overall reaction for introduction of the double bonds may likewise, therefore, be a condensation reaction.

The reaction can be accelerated by adding a catalyst, such as dibutyltin dilaurate, for example.

In a manner particularly advantageous for the process, the polymerization is followed by a concentration step, and the addition of the (isocyanatoethyl)acrylic esters and/or (isocyanatoethyl)methacrylic esters and the reaction of the functional groups with the (isocyanatoethyl)acrylic esters and/or (isocyanatoethyl)methacrylic esters take place in a single apparatus.

In one development of the invention, this operation takes place in an extruder; a devolatilizing extruder has been found very suitable for this purpose (reactive extrusion). Use may very suitably be made, for example, of a twin-screw extruder (Werner & Pfleiderer, ZSK 40). The acrylic PSAs prepared by the free-radical polymerization are concentrated in the extruder and freed from the solvent. In a manner which is advantageous for the process of the invention, the solvent content of the polymer composition following the concentration process is below 0.5% by weight. Following concentration the (isocyanatoethyl)acrylic esters and/or (isocyanatoethyl)methacrylic esters are added in the same apparatus as the concentration step. Here, the reaction takes place between the (isocyanatoethyl)acrylic esters and/or (isocyanatoethyl)methacrylic esters (isocyanatoethyl)acrylic ester and/or (isocyanatoethyl)methacrylic ester and the functional groups incorporated into the polymer chains.

In one advantageous version of the process, hydroxyl, amine, carboxylic acid and/or amide groups serve as functional groups.

Specific examples are monomers such as 2-hydroxyethyl acrylate, 2-hydroxypropyl acrylate, 4-hydroxybutyl acrylate, and their methacrylates, acrylic acid, methacrylic acid, t-butylaminoethyl methacrylate, acrylamides and methacrylamides, and allyl alcohol. This listing makes no claim to completeness.

In an advantageous procedure for the process of the invention the monomer used for the copolymerization is at least one compound of the following general formula

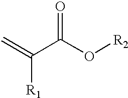

where R¹=H or CH₃ and the radical R₂ is chosen from the group of the branched or unbranched, saturated alkyl groups having 4 to 14, preferably 4 to 9, carbon atoms.

Specific examples of acrylic and methacrylic esters which can be used with advantage for the process of the invention are n-butyl acrylate, n-pentyl acrylate, n-hexyl acrylate, n-heptyl acrylate, n-octyl acrylate, n-nonyl acrylate, and the branched isomers thereof, such as 2-ethylhexyl acrylate, for example, without wishing to be restricted by this listing.

Acrylic monomers which may likewise be used advantageously for the process of the invention include alpha, beta unsaturated mono- and dicarboxylic acids having 3-5 carbon atoms.

It is likewise particularly favorable for the process of the invention if the monomer used for the copolymerization is at least one compound from the following group:

vinyl esters, vinyl ethers, vinyl halides, vinylidene halides, nitriles of ethylenically unsaturated hydrocarbons, vinyl compounds with aromatic rings and heterocycles in the α position.

As nonexclusive examples, without wishing to be restricted unnecessary by the selection, mention may be made here of the following: vinyl acetate, vinylformamide, vinylpyridine, acrylamides, acrylic acid, ethyl vinyl ether, vinyl chloride, vinylidene chloride, acrylonitrile, maleic anhydride, styrene and its derivatives.

Additionally it is of advantage if further acrylate monomers, such as methyl acrylates and methyl methacrylates, for example, which possess non-tacky properties, are used in combination with acrylic and vinylic monomers which are considered tacky. Through the amount and the selection of the comonomers the tackiness of the PSA is controlled.

The amount of (isocyanatoethyl)acrylic ester and/or (isocyanatoethyl)methacrylic ester used can be chosen here such that it corresponds stoichiometrically to the amount of functional groups available for an addition or condensation reaction. It is better, however, to choose a smaller amount of (isocyanatoethyl)acrylic ester and/or (isocyanatoethyl)methacrylic ester used.

Preferentially, the fraction of (isocyanatoethyl)acrylic ester and/or (isocyanatoethyl)methacrylic ester for the process of the invention is 0.1-20% by weight, based on the mixture of the monomers used.

By means of an “underdose” in respect of the fraction of functional groups available, complete or substantially complete reaction of the toxic isocyanato compounds is ensured, so that there are no residues of isocyanato compounds in the end product. For complete reaction of any residues of isocyanate which may nevertheless remain, it is possible after the operation operation of processing the PSA to carry out postcrosslinking, where appropriate, by irradiation, in particular using electrons.

Optionally it is also possible to add further functional monomers whose functional groups do not react with isocyanates. Such monomers might be N-substituted amides, tertiary amines or lactams. Specific examples are N-vinylformamide, N-vinylpyrrolidone and 4-vinylpyridine.

By way of the double bonds introduced it is possible to carry out crosslinking of the polyacrylates by exposure to high-energy radiation. This crosslinking may advantageously occur when the polyacrylate composition has already been subjected to further processing: for example, has been applied as a PSA to a backing. For the crosslinking it is possible to use, in particular, electron beams or, following the addition of photoinitiators, ultraviolet radiation as well. Examples of photoinitiators that may be mentioned, without wishing to impose unnecessary restriction, include cleaving (radical-forming) photoinitiators, especially α-cleavers, and hydrogen abstractors. For the group of the photo-cleaving initiators mention may be made by way of example of aromatic carbonyl compounds, especially benzoin derivatives, benzil ketals, and acetophenone derivatives. The hydrogen abstractors include, for example, aromatic ketones, such as benzophenone, benzil, thioxanthones.

Prior to electron beam crosslinking it is preferred to add crosslinkers to the polymer that is to be crosslinked. Suitable crosslinker substances in this context are difunctional or polyfunctional acrylates, difunctional or polyfunctional isocyanates or difunctional or polyfunctional epoxides. It is, however, also possible here to use any other difunctional or polyfunctional compounds which are familiar to the skilled worker and are capable of crosslinking polyacrylates.

Moreover, the polymers for preparing PSAs are optionally blended with resins. Examples of resins which can be used include terpene resins, terpenephenolic resins, C₅ and C₉ hydrocarbon resins, pinene resins, indene resins, and rosins, alone and also in combination with one another. In principle, however, it is possible to use any resins which are soluble in the corresponding polyacrylate; reference may be made in particular to all aliphatic, aromatic, and alkyl-aromatic hydrocarbon resins, hydrocarbon resins based on pure monomers, hydrogenated hydrocarbon resins, functional hydrocarbon resins, and natural resins.

It is additionally possible to add one or more additional additives such as plasticizers, various fillers (for example, carbon black, TiO₂, solid or hollow spheres of glass or other materials, silica, silicates, chalk), nucleators, blowing agents, accelerators, fatty acids, aging inhibitors, ozone protectants, light stabilizers and/or compounding agents. The addition of blocking-free isocyanates is a further possibility.

One further development which makes the process of the invention particularly advantageous for the preparation, for example, of adhesive tapes is distinguished by the fact that the PSA is processed further directly from the melt. The PSAs prepared in this process can be used to good effect for the hotmelt operation. Particularly the polyacrylates modified with acrylic ester are notable for high thermal stability and thus good suitability for the hotmelt operation.

Of particular advantage in accordance of the invention is a form of further processing where the hotmelt PSA is applied to a backing.

As backing material, for adhesive tapes for example, it is possible here to use the materials which are customary and familiar to the skilled worker, such as films (polyesters, PET, PE, PP, BOPP, PVC), nonwovens, foams, wovens, and woven films, and also release paper (for example glassine, HDPE, LDPE). This listing is not intended to be exclusive.

The invention further provides the pressure sensitive adhesive which has been obtained by the process of the invention or by one of its developments. The invention also encompasses the use of the pressure sensitive adhesive thus obtained for an adhesive tape, the acrylic pressure sensitive adhesive being present as a single-sided or double-sided film on a backing.

The process of the invention therefore embraces the preparation of a saturated polyacrylate which is modified in a polymer-analogous reaction with double bonds along the side chains.

As compared with nonfunctionalized polyacrylates, the polyacrylate hotmelt PSAs prepared by the process of the invention are significantly more reactive for the radical crosslinking of the polymer chains, especially crosslinking initiated by electron beams. The dose required for optimum crosslinking can be lowered, so reducing the amount of energy required and, in the case of electron beam crosslinking, subjecting the backing material to a lower level of damage. Moreover, a cohesion-enhancing effect has been achieved.

In contrast to polyacrylates modified by allylic double bonds, the thermal stability is not substantially lowered in the case of the polyacrylates produced by the inventive process. The thermal stability remains sufficiently high for processing in a hotmelt coating process. Accordingly, all-acrylate systems prepared in this way are gel-free for at least 48 hours at 140° C., resin-blended systems at 120° C.

### EXAMPLES

The invention is to be illustrated below by means of a number of examples, without wishing to be unnecessarily restricted thereby.

Depending on the desired adhesive properties of the acrylic hotmelts, a selection of acrylic and vinylic monomers is made.

Test Methods

The following test methods were employed to evaluate the adhesive properties of the PSAs prepared.

Shear Strength (Test A)

A strip of the adhesive tape 13 mm wide was applied to a smooth steel surface which had been cleaned three times with acetone and once with isopropanol. The area of application was 20 mm×13 mm (length×width). The adhesive tape is then pressed onto the steel substrate four times using a weight of 2 kg. A weight of 1 kg was fastened to the adhesive tape at room temperature, and the time taken for the weight to fall down was recorded.

The recorded shear stability times are reported in minutes and correspond to the average from three measurements.

Determination of the Gel Fraction (Test B)

The carefully dried, solvent-free samples of adhesive are welded into a pouch of polyethylene web (Tyvek nonwoven). The difference in the sample weights before and after extraction by toluene is used to determine the gel index, i.e., the toluene-insoluble weight fraction of the polymer.

Preparation of the Samples

The hydroxyl-functionalized acrylates and methacrylates used are available commercially. 2-HEA (2-hydroxyethyl acrylate) and 2-HEMA (2-hydroxyethyl methacrylate) were purified by distillation beforehand and stored under a nitrogen atmosphere.

### Example 1

A reactor conventional for free-radical polymerizations was filled with 500 g of 2-ethylhexyl acrylate, 400 g of methyl acrylate, 50 g of butyl acrylate, 50 g of 2-hydroxyethyl methacrylate and 540 g of acetone/special-boiling-point spirit (1:1). After nitrogen gas had been passed through for 45 minutes and the reactor had been degassed twice it was heated to 58° C. with stirring, and 0.2 g of azoisobutyronitrile (AIBN) was added. Thereafter the external heating bath was heated to 70° C. and the reaction was carried out constantly at this external temperature. After a reaction time of 1 hour a further 0.2 g of AIBN was added. After 3 hours and 6 hours, dilution was carried out in each case with 250 g of acetone/special-boiling-point spirit (1:1). The reaction was terminated after a reaction time of 24 hours, and the product was cooled to room temperature.

For adhesive testing, the adhesive was applied at a coverage of 50 g/m² to a primed PET film (23 μm thick), and was irradiated using an electron beam dose of 20 kGy with an accelerating voltage of 230 kV (electron beam unit from Crosslinking). This was followed by adhesive testing in accordance with test methods A and B.

### Example 2

The procedure was as in Example 1. The polymerization was carried out with 10 g of acrylic acid, 375 g of 2-ethylhexyl acrylate, 200 g of methyl acrylate, 375 g of butyl acrylate, 40 g of 2-hydroxyethyl acrylate and 540 g of acetone/special-boiling-point spirit (1:1). The amounts of solvent and initiator employed additionally were retained.

For adhesive testing, the adhesive was applied at a coverage of 50 g/m² to a primed PET film (23 μm thick). The specimens were then irradiated with an electron beam dose of 20 kGy. Adhesive testing was carried out in accordance with test methods A and B.

### Example 3

The procedure was as in Example 1. The polymerization was carried out with 20 g of acrylic acid, 810 g of 2-ethylhexyl acrylate, 50 g of methyl acrylate, 120 g of 2-hydroxyethyl methacrylate and 540 g of acetone/special-boiling-point spirit (1:1). The amounts of solvent and initiator employed additionally were retained.

For adhesive testing, the adhesive was applied at a coverage of 50 g/m² to a primed PET film (23 μm thick). The specimens were then irradiated with an electron beam dose of 15 kGy. Adhesive testing was carried out in accordance with test methods A and B.

### Example 4

The procedure was as in Example 1. The polymerization was carried out with 20 g of acrylic acid, 430 g of 2-ethylhexyl acrylate, 100 g of methyl acrylate, 430 g of butyl acrylate, 20 g of 2-hydroxyethyl acrylate and 540 g of acetone/special-boiling-point spirit (1:1). The amounts of solvent and initiator employed additionally were retained.

For adhesive testing, the adhesive was applied at a coverage of 50 g/m² to a primed PET film (23 μm thick). The specimens were then irradiated with an electron beam dose of 25 kGy. Adhesive testing was carried out in accordance with test methods A and B.

### Example 1′

100 g of the acrylic PSA from 1 were mixed with 1.36 g of (isocyanatoethyl)acrylic ester and heated at 50° C. for 30 minutes under a nitrogen atmosphere. Thereafter the solvent was removed under reduced pressure and with heating, and the adhesive was melted as an acrylic hotmelt and then coated at 50 g/m² onto a primed PET film (23 μm thick). The specimens were irradiated with an electron beam dose of 20 kGy. Adhesive testing was carried out in accordance with test methods A and B.

### Example 2′

100 g of the acrylic PSA from 2 were mixed with 1.88 g of (isocyanatoethyl)methacrylic ester and heated at 50° C. for 30 minutes under a nitrogen atmosphere. Thereafter the solvent was removed under reduced pressure and with heating, and the adhesive was melted as an acrylic hotmelt and then coated at 50 g/m² onto a primed PET film (23 μm thick). The specimens were irradiated with an electron beam dose of 20 kGy. Adhesive testing was carried out in accordance with test methods A and B.

### Example 3′

100 g of the acrylic PSA from 3 were mixed with 0.87 g of (isocyanatoethyl)acrylic ester and heated at 50° C. for 30 minutes under a nitrogen atmosphere. Thereafter the solvent was removed under reduced pressure and with heating, and the adhesive was melted as an acrylic hotmelt and then coated at 50 g/m² onto a primed PET film (23 μm thick). The specimens were irradiated with an electron beam dose of 15 kGy. Adhesive testing was carried out in accordance with test methods A and B.

### Example 3″

100 g of the acrylic PSA from 3 were mixed with 3.48 g of (isocyanatoethyl)acrylic ester and heated at 50° C. for 30 minutes under a nitrogen atmosphere. Thereafter the solvent was removed under reduced pressure and with heating, and the adhesive was melted as an acrylic hotmelt and then coated at 50 g/m² onto a primed PET film (23 μm thick). The specimens were irradiated with an electron beam dose of 15 kGy or 5 kGy. Adhesive testing was carried out in accordance with test methods A and B.

### Example 4′

100 g of the acrylic PSA from 4 were mixed with 3.20 g of (isocyanatoethyl)acrylic ester and heated at 50° C. for 30 minutes under a nitrogen atmosphere. Thereafter the solvent was removed under reduced pressure and with heating, and the adhesive was melted as an acrylic hotmelt and then coated at 50 g/m² onto a primed PET film (23 μm thick). The specimens were irradiated with an electron beam dose of 25 kGy or 5 kGy. Adhesive testing was carried out in accordance with test methods A and B.

Results

The comonomers investigated for the preparation of the acrylic PSAs are listed in Table 1. Polymerization was carried out conventionally using AIBN (azoisobutyronitrile) in a mixture of acetone/special-boiling-point spirit.

TABLE 1

| | | 2-EHA | | n-BA | 2-HEA | 2-HEMA |
|---|---|---|---|---|---|---|
| Ex. | AS [%] | [%] | MA [%] | [%] | [%] | [%] |
| 1 | 0 | 50 | 40 | 5 | 0 | 5 |
| 2 | 1 | 37.5 | 20 | 37.5 | 4 | 0 |
| 3 | 2 | 81 | 5 | 0 | 0 | 12 |
| 4 | 2 | 43 | 10 | 43 | 2 | 0 |

AS: acrylic acid; 2-EHA: 2-ethylhexyl acrylate; MA: methyl acrylate; n-BA: n-butyl acrylate; 2-HEA: 2-hydroxyethyl acrylate; 2-HEMA: 2-hydroxyethyl methacrylate.

In addition to the polymer-analogous reaction, examples 1-4 were used as well for reference purposes. With these specimens it is intended to illustrate the differences in respect of cohesion and crosslinkability as compared with the vinyl-modified polyacrylates.

For this purpose, the polymers were applied conventionally from solution to a primed polyester film (23 μm thick). After drying at 120° C. for 10 minutes, the application coverage of the pure adhesives was 50 g/m². After curing with electron beams, the gel index (weight fraction of the polymer which is insoluble in toluene) of the irradiated specimens was measured. The gel index is an indication of the efficiency of the crosslinking and provides very good comparability in the case of irradiation with the identical electron beam dose. In order to assess the adhesive properties, moreover, a shear test was conducted at room temperature. With the shear test it is possible to draw conclusions about the cohesion of an adhesive. Table 2 sets out the results.

TABLE 2

| | | | Shear stability |
|---|---|---|---|
| | Electron beam | Gel index | time RT, 10 N |
| Example | dose [kGy] | [%] | [min] |
| 1 | 20 | 43 | 2475 |
| 2 | 20 | 41 | 2055 |
| 3 | 15 | 34 | 4530 |
| 4 | 25 | 46 | 2325 |

### Application Coverage in Each Case 50 g/m²

All of the examples were cured using electron beams, but employing different electron beam doses depending on specimen. The gel indices achieved vary and are dependent on the polyacrylate and on the electron beam dose. Overall, the level is relatively low at approximately 40% insoluble fraction in toluene. As a result, the cohesion of these adhesives is also very low. The shear strength lay in all cases clearly below the required level of 10 000 minutes, which ought to be achieved by an acrylic PSA tape of high shear strength under a shearing weight of 10 N at room temperature.

With these results as a reference, examples 1-4 were reacted with the compounds (isocyanatoethyl)acrylic ester or (isocyanatoethyl)methacrylic ester. The amounts of isocyanates used are set out in summary form in Table 3.

TABLE 3

| | | Mole | (Isocyanoato- | (Isocyanoato- |
|---|---|---|---|---|
| | Base | equiv. of | ethyl) | methacrylic |
| Ex. | polymer | isocyanate | acrylic ester | ester |
| 1′ | 1 | 0.25 | 1.36% by wt. | 0 |
| 2′ | 2 | 0.25 | 0 | 1.88% by wt. |
| 3′ | 3 | 0.1 | 0.87% by wt. | 0 |
| 3″ | 3 | 0.75 | 3.48% by wt | 0 |
| 4′ | 4 | 0.5 | 3.20% by wt. | 0 |

Example 1′ was reacted with 0.25 mole equivalents of (isocyanatoethyl)acrylic ester. In contrast, Example 3 was reacted with different amounts of the (isocyanatoethyl)acrylic ester. Example 2 was reacted for comparison with 0.25 mole equivalents of (isocyanatoethyl)methacrylic ester.

For the reaction of example 4, 0.5 mole equivalents of (isocyanatoethyl)acrylic ester were used. For the complete reaction of any residues of isocyanate that remain, the hotmelt coating operation of the pressure sensitive adhesive is followed by optional crosslinking with electron beams. In the course of irradiation, free radicals are formed along the polymer chains, and react with unreacted isocyanates by way of the double bond. Accordingly, the toxic isocyanates are bound lastingly into the pressure sensitive adhesive and cannot escape from the adhesive even on storage for a relatively long period of time. Accordingly, there is no problem of toxicity for the user.

After the reaction had been carried out, examples 1′-4′ were coated through a die onto a primed polyester backing (23 μm thick) in the form of a hotmelt and were then cured with electron beams in analogy to Table 2. This was followed by adhesive testing. During the hotmelt operation, temperatures of between 100 and 120° C. occurred but did not lead to gelling of the individual PSAs. The application coverage of the pure acrylic PSA was again 50 g/m². The electron beam doses used were identical. The results of these tests are summarized in Table 4.

TABLE 4

| | | | Shear stability |
|---|---|---|---|
| | Electron beam | Gel index | time RT, 10 N |
| Example | dose [kGy] | [%] | [min] |
| 1′ | 20 | 74 | 7 765 |
| 2′ | 20 | 66 | +10 000 |
| 3′ | 15 | 62 | +10 000 |
| 3″ | 15 | 85 | 5 |
| 4′ | 25 | 90 | 5 |

### 50 g/m² Application Coverage

The effect of the double bonds on electron beam crosslinking is considerable. At the same dose, the gel index increases dramatically. Specimens 3″ and 4′ are overcrosslinked and possess hardly any pressure-sensitively adhesive properties. In the case of examples 1′, 2′, and 3′, on the other hand, it is evident that the more efficient crosslinking has an unambiguously positive effect on the cohesion. In the 10 N shearing test, specimens 2′ and 3′ achieve a value of more than 10 000 minutes. The cohesion of specimen 1′ also increases significantly. In order to determine the optimum cohesion, specimens 3″ and 4′ were irradiated again with a lower electron beam dose (see Table 5).

TABLE 5

| | | | Shear stability |
|---|---|---|---|
| | Electron beam | Gel index | time RT, 10 N |
| Example | dose [kGy] | [%] | [min] |
| 3″ | 5 | 61 | +10 000 |
| 4′ | 5 | 65 | +10 000 |

### Application Coverage 50 g/m² in Each Case

With an electron beam dose of just 5 kGy, a gel index of more than 60% was achieved for specimens 3″ and 4′. The crosslinking range, which is optimum for these specimens, in turn raises the cohesion of these PSAs and the shear stability times of greater than 10 000 minutes at RT under a shearing weight of one kilo.

1. A process for preparing an acrylic-based pressure sensitive adhesive, characterized in that
a) first of all (co)polymers are prepared from the following monomers by free radical polymerization:
i) a mixture of acrylic monomers or of acrylic and vinylic monomers
ii) monomers which contain vinyl groups and each have at least one functional group which is unreactive in respect of free-radical polymerization, the functional groups being chosen such that they are able to undergo polymer-analogous reactions with isocyanato groups,
with a fraction of 0.1 to 25% by weight in the monomer mixture,
b) double bonds are introduced along the polymer chain by a further reaction with the addition of (isocyanatoethyl)acrylic esters and/or (isocyanatoethyl)methacrylic esters, and
c) after the reaction between the functional groups and the isocyanato groups the polymers are crosslinked through exposure to high-energy radiation.

2. The process of one of the preceding claims, characterized in that the polymerization is followed by a concentration step until the solvent content following concentration is no longer greater than 2% by weight, in particular not greater than 0.5% by weight, and the concentration step, the addition of the (isocyanatoethyl)acrylic esters and/or (isocyanatoethyl)methacrylic esters, and the reaction of the functional groups with the (isocyanatoethyl)acrylic ester and/or (isocyanatoethyl)methacrylic ester takes place in a single apparatus, in particular in an extruder.

3. The process of one of the preceding claims, characterized in that hydroxyl, amine, carboxylic acid and/or amide groups serve as functional groups.

4. The process of one of the preceding claims, characterized in that at least one compound of the following general formula is used as a monomer for the copolymerization: 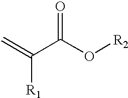
where R¹=H or CH₃ and the radical R₂ is chosen from the group of the branched or unbranched, saturated alkyl groups having 4 to 14, preferably 4 to 9, carbon atoms.

5. The process of one of the preceding claims, characterized in that at least one compound from the following group is used as a monomer for the copolymerization:
vinyl esters, vinyl ethers, vinyl halides, vinylidene halides, nitrites of ethylenically unsaturated hydrocarbons, vinyl compounds with aromatic rings and heterocycles in the α position.

6. The process of one of the preceding claims, characterized in that the fraction of (isocyanatoethyl)acrylic ester and/or (isocyanatoethyl)methacrylic ester comprises 0.1-20% by weight; based on the comonomer composition.

7. The process of one of the preceding claims, characterized in that the pressure sensitive adhesive is subjected to further processing from the melt, and in particular is applied to a backing.

8. An adhesive tape with an acrylic pressure sensitive adhesive applied on one or both sides of a backing, in accordance with a process of one of the preceding claims.
